(19) United States
(12) Patent Application Publication
(10) Pub. No.: US 2025/0110795 A1
(43) Pub. Date: Apr. 3, 2025

(54) ASSURING PERFORMANCE IN A COMPUTING ENVIRONMENT USING AN ATTRIBUTE DEPENDENCY GRAPH TO ALLOCATE RESOURCES

(71) Applicant: Causely, Inc., Newton, MA (US)

(72) Inventors: Shmuel Kliger, New York, NY (US); Christine Miller, Westfield, NJ (US); Steffen Geissinger, Schwetzingen (DE); Endre Sara, Briarcliff Manor, NY (US); Enlin Xu, Millburn, NJ (US); Sumanyu Muku, Jersey City, NJ (US)

(21) Appl. No.: 18/424,039

(22) Filed: Jan. 26, 2024

Related U.S. Application Data
(60) Provisional application No. 63/587,586, filed on Oct. 3, 2023.

(51) Int. Cl. G06F 9/50; G06F 11/34

(52) U.S. Cl. CPC G06F 9/5044; G06F 9/5033; G06F 11/3447

(57) ABSTRACT

A system, method, and a computer program product for allocating and configuring resources to an application in a computing environment are provided. An attributes dependency graph is generated from an attributes dependency model defining a plurality of attributes. The plurality of attributes correspond to a plurality of resources and performance metrics in a computing environment. The vertices in the attributes dependency graph correspond to the attributes. The edges in the attributes dependency graph correspond to functions identifying relationships between at least two vertices. A factor graph is generated from the attributes dependency graph and a constraints model. The constraint model specifies at least one constraint for an application executing in the computing environment. A subset of resources in the computing environment is allocated or configured to the application based on the factor graph.

### CROSS-REFERENCE TO RELATED APPLICATIONS

This application claims priority under 35 U.S.C. 119 to U.S. Provisional Application No. 63/587,586, filed Oct. 3, 2023, each of which are hereby expressly incorporated by reference herein in its entirety.

### TECHNICAL FIELD

This application relates generally to performance assurance in a computing environment, and more specifically to optimizing computer resources using an attributes dependency graph.

### BRIEF DESCRIPTION OF THE DRAWINGS

FIG. 1 is a simplified diagram of a computing environment where embodiments may be implemented.

FIG. 2 is a diagram of a performance assurance framework, according to some embodiments.

FIGS. 3-12A-E are diagrams of example topologies and corresponding attributes dependency graphs, according to some embodiments.

FIGS. 13A-C are diagrams of factor graphs generated from a constraints model and an attributes dependency graph, according to some embodiments.

FIG. 14 is a flowchart of a method for assigning computing resources to an application, according to an embodiment.

FIG. 15 is an embodiment of a computer system suitable for implementing, the systems and methods described in FIGS. 1-14.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The embodiments are directed to a performance assurance framework. The performance assurance framework computes resource allocation and/or configurations in a computing environment to various applications. As used herein, the term “framework” may comprise hardware or software-based framework that performs one or more functions.

The performance assurance framework may determine an amount of resource that may be assigned to applications in a computing environment. The assignment may be based on available resources and one or more constraints. Assigning resources to applications based on constraints may improve the utilization of the computing environment, reduce bottlenecks, and predict performance issues that may occur in the computing environment in the future.

To assign resources to an application, the performance assurance framework may receive an attributes dependency model and a topology. The attributes dependency model lists attributes in an attributes dependency model language. Attributes may represent resources in a computing environment and performance metrics. Example resources may be a processor, a memory, input devices, communications, and the like. Example performance metrics may be requests made to a processor, processor units per request, process utilization, memory utilization, service latency, application latency, application cost, and the like. The topology comprises entities and relationship between entities. Non-limiting examples of entities may include hosts, virtual machines, nodes, pods, containers, disks, databases, applications, processes, services, and the like. Non-limiting examples of relationships may include connectivity between services, connectivity between applications, connectivity between services and databases, layering between services and pods, layering between pods and nodes, layering between databases and pods, composition between applications and services, compositions between pods and containers, and the like. Using the attributes dependency model and the topology, the performance assurance framework may generate an attributes dependency graph. The attributes dependency graph may include vertices that are attributes and directed edges that are associated with functions indicating a relationship between the attributes. The attributes in the attributes dependency graph may be attributes derived from the attributes dependency model and the topology. By traversing the attributes dependency graph using edges and applying functions that correspond to the edges to the attributes during the traversal, the performance assurance framework may determine resources that may be used by one or more applications in the computing environment.

In some instances, the performance assurance framework may also receive training data. The performance assurance framework may use the training data to train a machine learning framework to determine the functions that correspond to the edges in the attributes dependency graph. The training data may include attributes and functions of the previously generated attributes dependency graphs.

In some embodiments, the performance assurance framework receives a constraints model. The constraints model may specify resource constraints, such as capacity, utilization, budget, etc., and performance objectives, such as latency, requests, response time, etc., associated with the one or more applications and one or more services the applications use while executing in a computing environment. In some instances, the constraints model may be included in the attributes dependency model.

The performance assurance framework may use the attributes dependency graph and the constraints model to generate a factor graph. The factor graph may be a network, such as a Bayesian network, of constraints and variables, where variables are resources and performance metrics in the computing environment that the constraints depend on. In some embodiments, the performance assurance framework may use training data to define one or more factors in the factor graph. From the factor graph, the performance assurance framework may allocate and/or configure a portion of resources in the computing environment to one or more applications that satisfy the constraints.

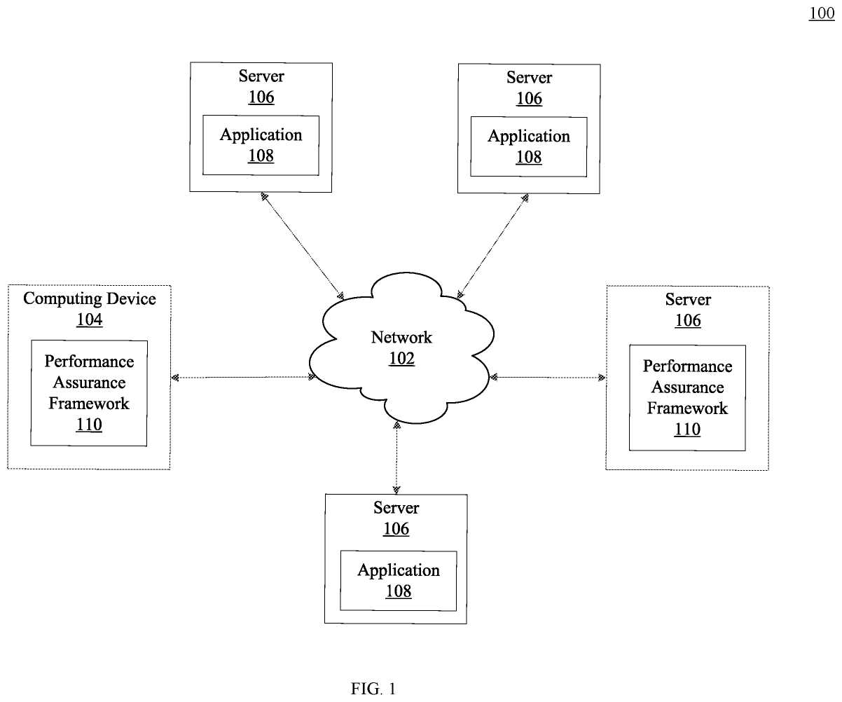

FIG. 1 is an exemplary computing environment 100 where embodiments can be implemented. Computing environment 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network. Network 102 may be accessible by various components of computing environment 100.

Computing environment 100 also includes one or more computing devices 104 and servers 106, although only a few are shown. Computing devices 104 may be portable and non-portable electronic devices under control of a user and configured to transmit, receive, manipulate data, execute various applications, and communicate with other devices connected to network 102. Example computing devices 104 may be desktop computers, laptop computers, tablets, smartphones, wearable computing devices, eyeglasses that incorporate computing devices, implantable computing devices, etc.

In some embodiments, network 102 may also include servers 106. Servers 106 may be computer software programs or hardware devices that allow computing devices 104 to access applications 108 executing on the servers 106, provide processing capabilities and facilitate distribution of data throughout network 102.

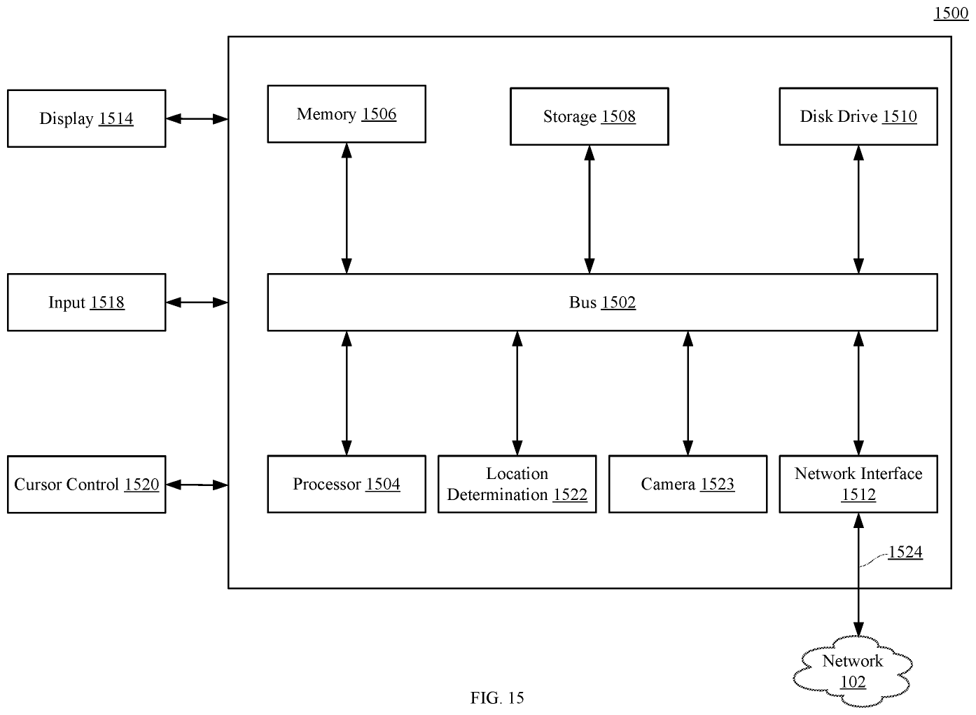

Computing environment 100 may include resources. In a non-limiting environment, resources may be hardware resources such as processors, random access, read-only, and hard disk memories, input devices, communication hardware, etc., that are distributed throughout computing environment 100, including on computing devices 104, servers 106 and within network 102. Example hardware resources are also illustrated in FIG. 15. Resources may also be software resources, such as system software, operating systems, virtual machine, container, application software, device drivers, utility software, among others. Typically, there is a finite number of resources in computing environment 100.

Servers 106 in computing environment 100 may execute one or more applications 108. Applications 108 may use hardware and software resource while executing. Because applications 108 may be different types of applications, each one of applications 108 may use a different amount and type of resources or a combination of resources, such as processor speed and power, memory, network bandwidth and the like.

Allocating and/or configuring resources to applications 108 within the application constraints is advisable in computing environment 100. Such allocation and configuration of resources reduces issues related to under or over utilization of resources, resource starvation, latency, system crashes, available bandwidth, and other adverse events in computing environment 100. To efficiently allocate and/or configure resources to applications 108, computing devices 104 and/or servers 106 may store and execute a performance assurance framework 110. Performance assurance framework 110 may be implemented in software and/or hardware that has sequential and parallel processing capabilities. Performance assurance framework 110 may be installed in computing environment 100 and collect data associated with various devices and applications with computing environment 100. Performance assurance framework 110 may use the collected data to determine an amount and type of resources to allocate to one or more applications 108 within constraints, such as latency, cost, etc., that are associated with applications 108. Performance assurance framework 110 may also predict root causes of issues that may occur in computing environment 100 in the future.

In some embodiments, performance assurance framework 110 may execute on one or more computing devices 104 or servers 106. In other embodiments, performance assurance framework 110 may execute in part on one or more computing devices 104 and in part on one or more servers 106. For example, a user interface portion of the performance assurance framework 110 may execute on computing device 104. The user interface may receive definitions for the attributes and attribute dependencies in the attributes dependency model (ADM) language, receive constraint information for the constraints model, display resource allocation recommendations, display attributes dependency graphs and factor graphs, etc. A portion of the performance assuring framework 110 that generates the attributes dependency graphs, factor graphs, and resource allocation and/or configuration assignments and recommendations may execute on the server 106.

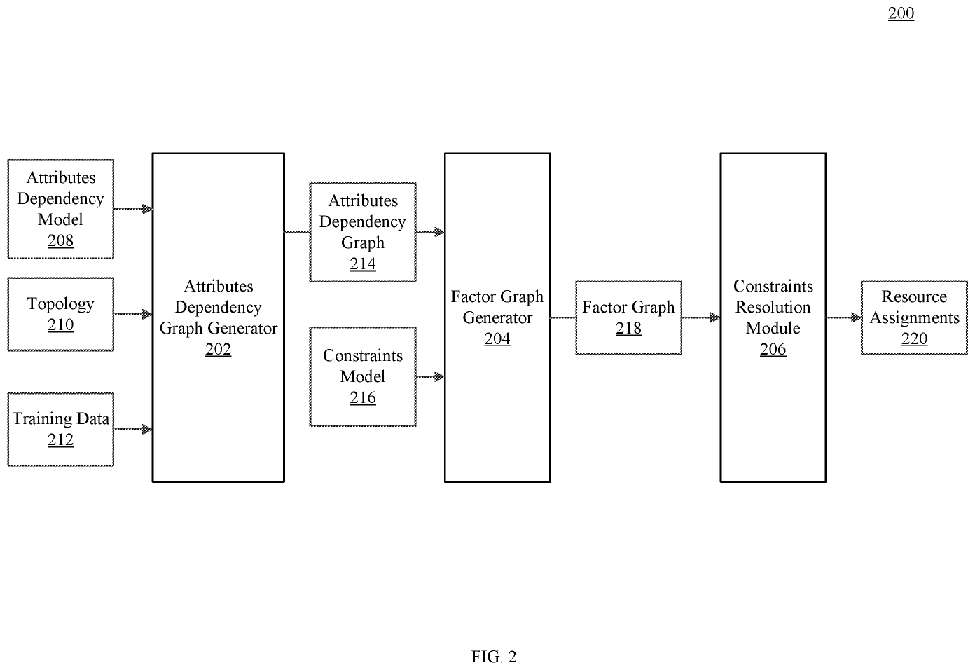

FIG. 2 is a diagram 200 of a performance assurance framework, according to some embodiments. Performance assurance framework 110 may include an attributes dependency graph generator 202, a factor graph generator 204, and a constraints resolution module 206. Attributes dependency graph generator 202, factor graph generator 204, and constraints resolution module 206 may be implemented using specialized hardware, software, or a combination thereof.

Attributes dependency graph generator 202 may receive an attributes dependency model 208, a topology 210, and training data 212 and may generate an attributes dependency graph (ADG) 214. Attributes dependency model 208 may name and define attributes in a computing environment 100. Attributes may be resources in computing environment attributes 100 and performance metrics. Example resources attributes may be a processor utilization, a memory utilization, input device capacity, and the like. Example performance metrics may be requests made to a processor, processor units per request, service latency, application latency, application cost, and the like. Attributes dependency model 208 may also define a relationship between different attributes using functions. The functions may be defined using expressions. The expressions can be a number, another attribute, an operation between or among attributes, an aggregation of the attributes, and the like. In some instances, the attributes and the relationships between the attributes may be defined using an attribute dependency model (ADM) language.

Topology 210 may include relationships between different computing entities in a computing environment. As discussed above, topology 210 comprises entities and indicates relationships between entities. Some examples of entities may include hosts, virtual machines, nodes, pods, containers, disks, databases, applications, processes, services, and the like. Non-limiting examples of relationships may include connectivity between services, connectivity between applications, connectivity between services and databases, layering between services and pods, layering between pods and nodes, layering between databases and pods, composition between applications and services, compositions between pods and containers, and the like. In an exemplary embodiment, topology 210 may indicate that a host, a virtual machine or a pod is underlying a service and has a one to one or one to many relationship with other services, and the like.

Training data 212 may include attributes defined in the ADM and values associated with different attributes. Attributes dependency graph generator 202 may use the values in the training data 212 to determine functions associated with edges between nodes in the attributes dependency graph (ADG) 214. The functions may represent a relationship between the nodes. For example, while some relationships may be defined using expressions in the ADM language, other relationships may be derived from the training data 212. Training data 212 may be data that performance assurance framework 110 collects from various devices in computing environment 100 once performance assurance framework 110 is deployed in computing environment 100. Training data 212 may also be data associated with another system. This training data may be used as default data for determining edges in ADG 214. In another example, training data 212 may be a combination of data collected from computing environment 100 and default data from another system. In this embodiment, data collected from another system may be used to determine functions for edges for which performance assurance framework 110 has not be able to collect data from computing environment 100 or for edges for which performance assurance framework 110 is still collecting or has yet to collect data.

As discussed above, attributes dependency graph generator 202 of performance assurance framework 110 may receive attributes dependency model 208 and topology 210 to generate ADG 214. The ADG 214 may include vertices that are attributes and edges that are functions indicating a relationship between the attributes. The attributes may be attributes included in the attributes dependency model 208 or attributes derived using the attributes dependency model 208 and the topology 210. The edges that connect the vertices in the ADG 214, and may be directed edges that lead from one vertex to another vertex. The edges may be associated with functions that represent a relationship between the vertices. The functions may be included in the attribute dependency model 208 or be derived from training data 212.

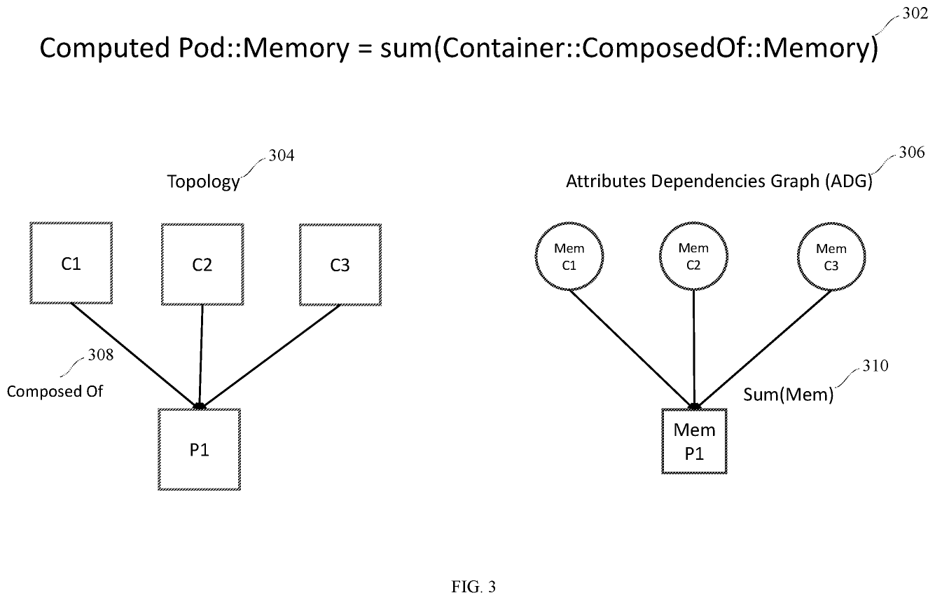

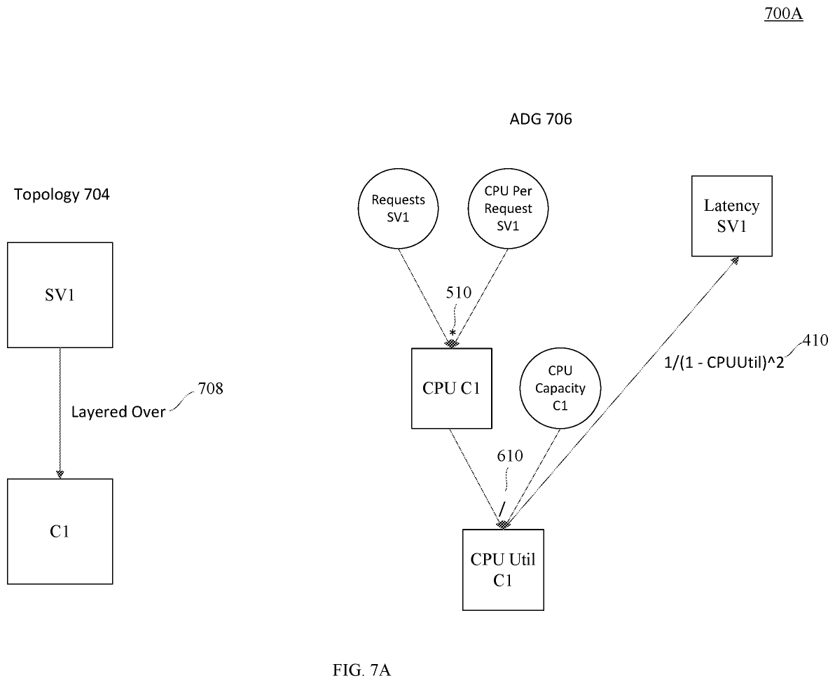

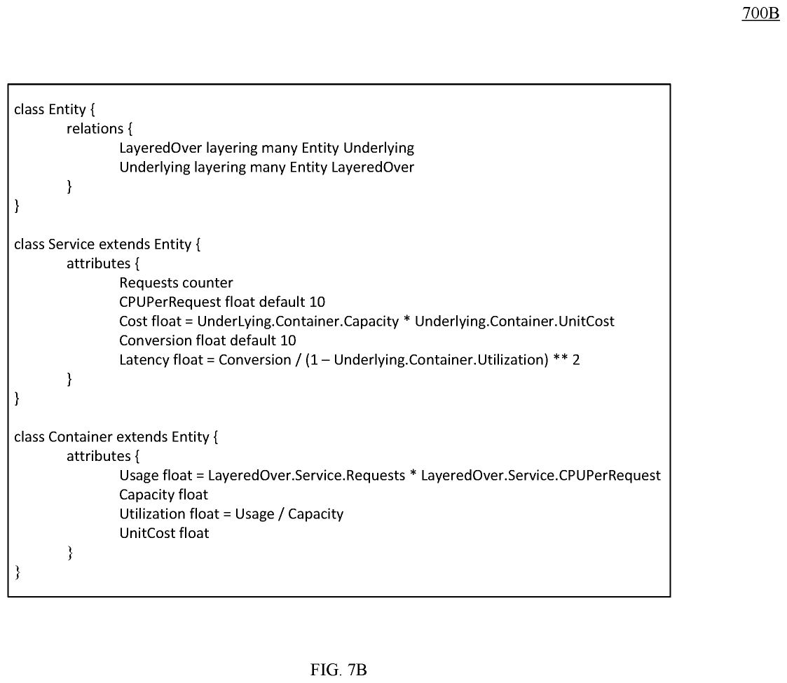

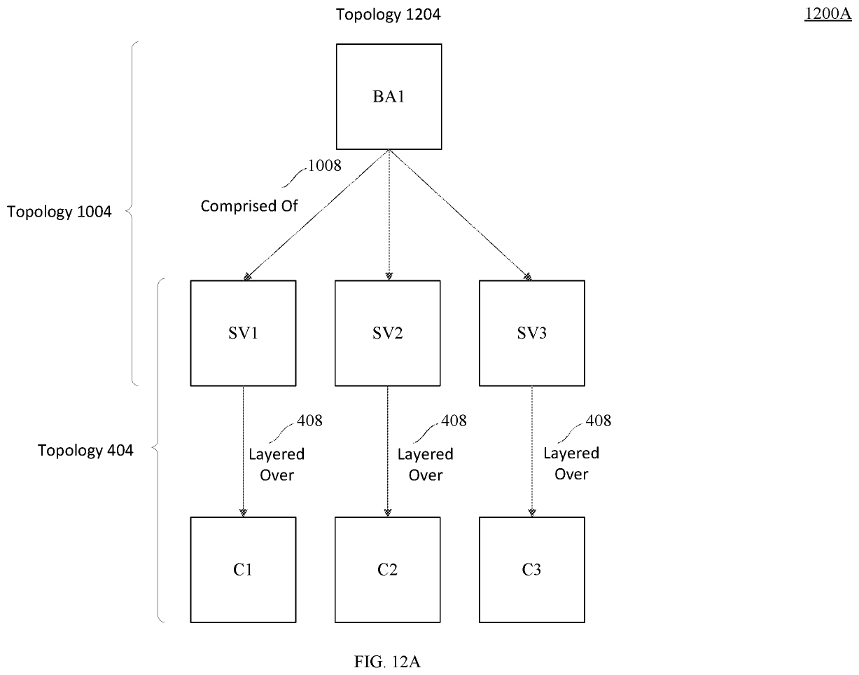

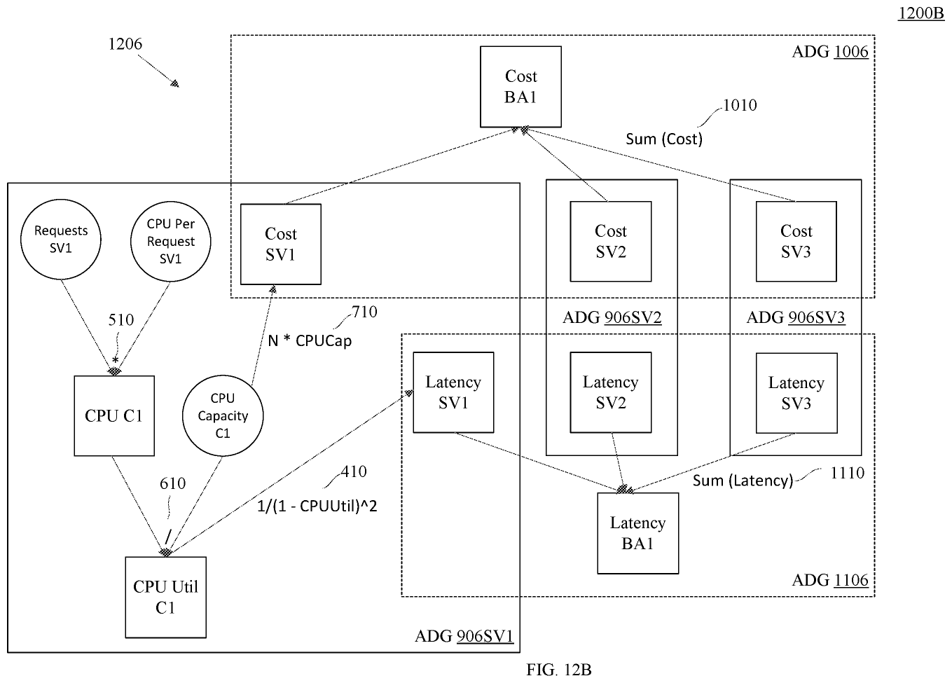

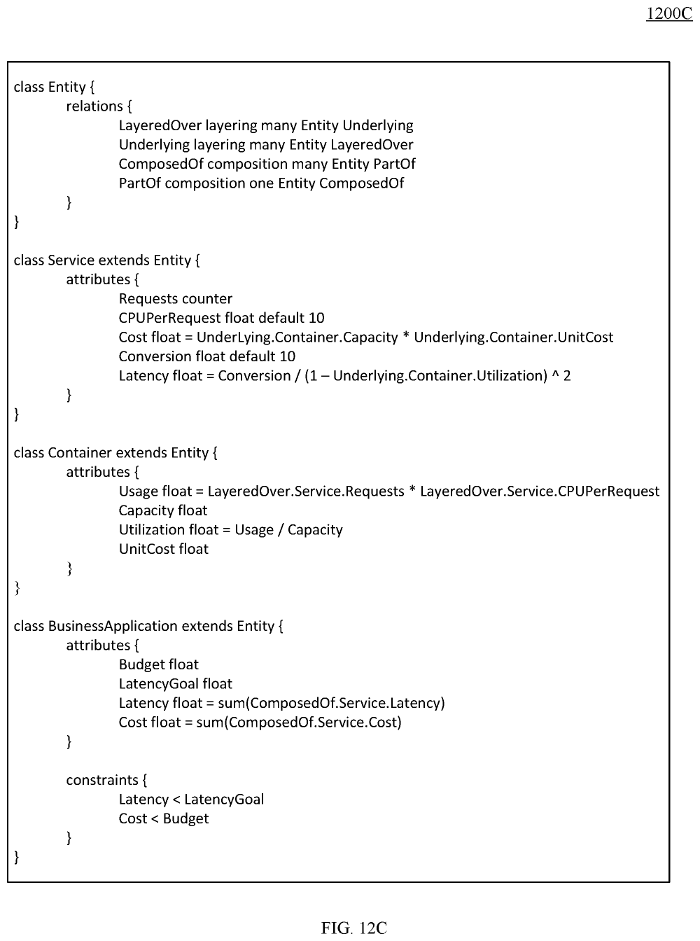

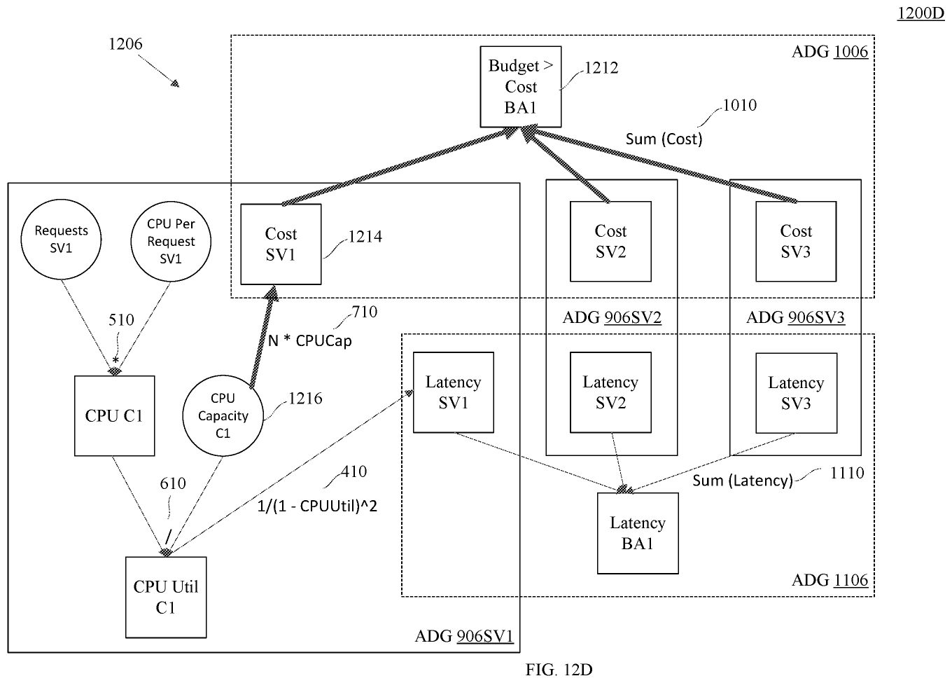

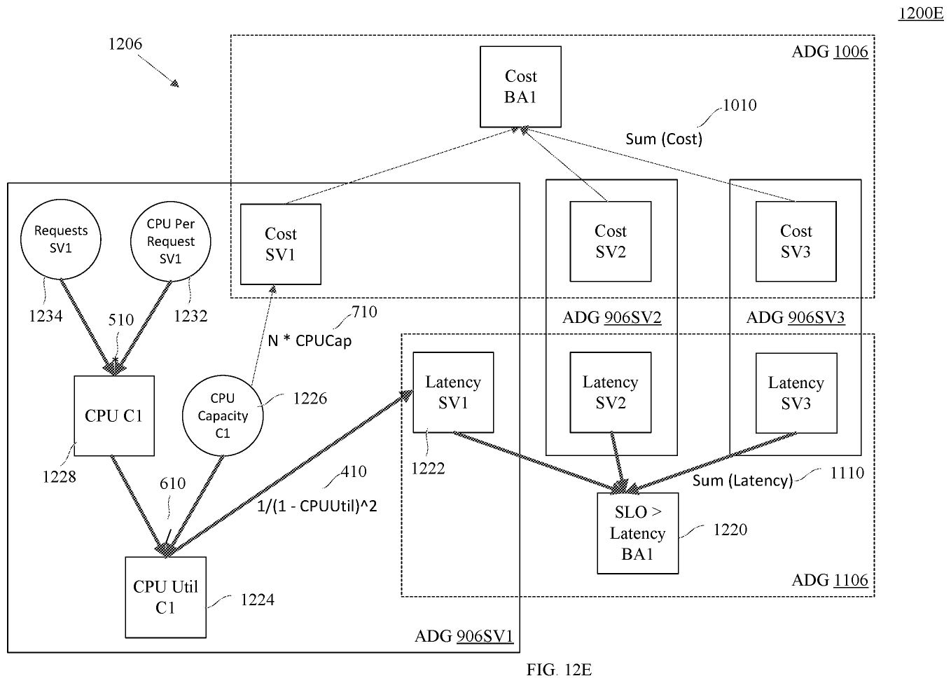

FIGS. 3-7A, 8-12B, and 12D-13 are diagrams 300-700A, 800-1200B, and 1200D-1300 of example attribute dependency models, topologies, and corresponding attributes dependency graphs that are generated from the attribute dependency models and topologies, according to some embodiments. FIG. 7B is a diagram 700B illustrating pseudocode that generates an attributes dependency graph shown in FIG. 7A. FIG. 12C is a diagram 1200C illustrating pseudocode that generates an attributes dependency graph shown in FIGS. 12A-B and D-E.

FIG. 3 illustrates an attributes dependency model 302, a topology 304, and an ADG 306 that was generated from attributes dependency model 302 and topology 304. Attributes dependency model 302 may define a dependency between attributes of pod and containers. In FIG. 3, attribute dependency model 302 defines a dependency as a memory of a pod being a sum of memories of the containers that compose the pod. Topology 304 indicates a relationship 308 among the three containers C1, C2, and C3 and pod P1. Specifically, topology 304 indicates that pod P1 is composed of containers C1, C2, and C3. Based on attributes dependency model 302 and topology 304, attributes dependency graph generator 202 may generate ADG 306 that shows attributes, such as memories of containers C1, C2, and C3, and a memory of a pod P1 as vertices, and the relationship 310 among the attributes, e.g., the sum of memories of containers C1, C2, and C3 being the memory of pod P1, using the edges. The direction of the edges represents the dependency between the attributes. For example, the memory of pod P1 is computed from the memories of other attributes, such as the memories of containers C1, C2, and C3. Notably, attributes dependency model 302 may apply to different topologies to generate different ADGs. For example, attributes dependency model 302 may apply to a topology that illustrates a relationship between pod P1 and two containers C1 and C2. In this case, the corresponding ADG may include a relationship between the memory of pod P1 and memories of containers C1 and C2 (not shown).

In some embodiments, attributes may be free or independent attributes or dependent attributes. The free or independent attributes are not computed from other attributes and may represent resources in computing environment, while dependent attributes are computed from the other attributes and may represent performance metrics. The ADG 306 in FIG. 3 illustrates free or independent attributes and dependent attributes using different geometric shapes. In a non-limiting example, attributes that are memories of containers C1, C2, and C3 are represented as circles and attribute pod P1 is represented as a square. The circle attributes represent free attribute that are not computed from other attributes in the computing environment 100. Notably, edges in ADG 306 lead from the circle attributes to other attributes, but do not lead to the circle attributes. The square attributes represent attributes that are dependent attribute and are computed from other attributes. Notably, edges in ADG 306 lead from the circle attributes to the square, which indicates that the square attributes are computed from other attributes.

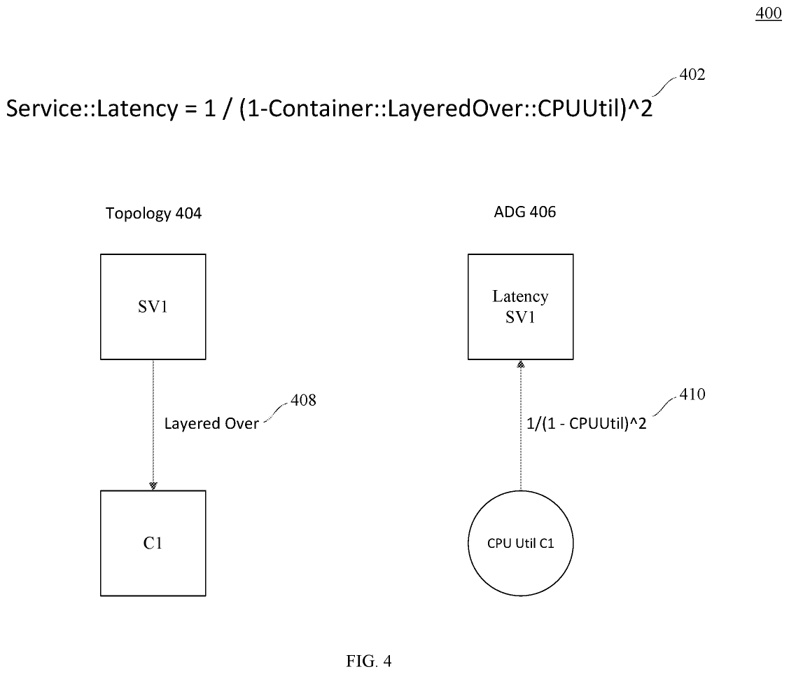

FIG. 4 illustrates an attributes dependency model 402, a topology 404, and an ADG 406 that was generated from attributes dependency model 402 and topology 404. Attributes dependency model 402 may define a dependency between an attribute that is a latency of a service and an attribute that is a CPU utilization of a container. In particular, attribute dependency model 402 defines dependency as a latency of a service that is inversely proportional to a function that includes the CPU utilization of a container to a power of two. Topology 404 indicates a relationship 408 between a service SV1 and a container C1. Specifically, topology 404 indicates that service SV1 is layered over container C1. Based on attributes dependency model 402 and topology 404, attributes dependency graph generator 202 may generate ADG 406 that shows latency of service SV1 and CPU utilization of the container C1 as vertices, and a relationship 410, e.g., an inverse relationship of CPU utilization to a power of two, as an edge. Moreover, the vertex corresponding to the CPU utilization of the container C1 indicates that the CPU utilization of the container C1 is an independent attribute and the vertex corresponding to the latency of the service SV1 indicates that the latency of the service SV1 is a dependent attribute.

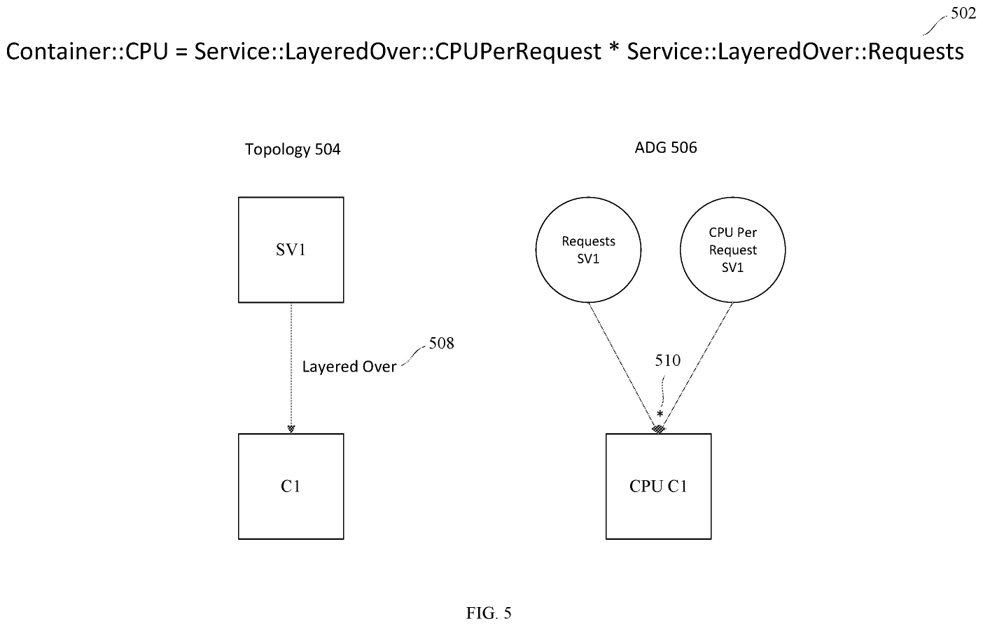

FIG. 5 illustrates an attributes dependency model 502, a topology 504, and an ADG 506 that was generated from attributes dependency model 502 and topology 504. Attributes dependency model 502 may define a dependency between attributes that are a CPU of a container, requests of a service, and CPU cycles per request from the service. In particular, attribute dependency model 502 defines a dependency as a CPU of a container that is equal to a product of a number of requests from a service and CPU cycles per request from the service. Topology 504 indicates a relationship 508 between a service SV1 and container C1. Specifically, topology 504 indicates that the service SV1 is layered over container C1. Topology 504 may be the same as topology 404 discussed in FIG. 4. Based on attributes dependency model 502 and topology 504, attributes dependency graph generator 202 may generate ADG 506 that includes the CPU of container C1, requests of service SV1 and CPU cycles per request of service SV1 as vertices, and a relationship 510, e.g., a product of a number of requests of service SV1 and CPU cycles per request of service SV1, as edges.

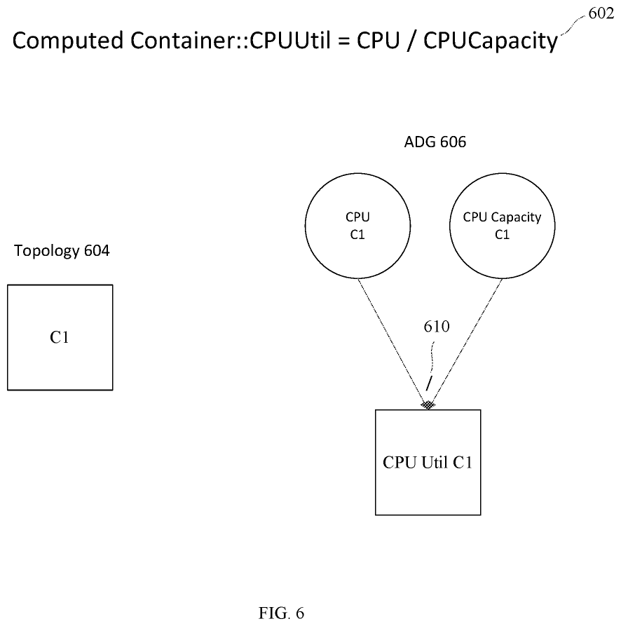

FIG. 6 illustrates an attributes dependency model 602, a topology 604, and an ADG 606 that was generated from attributes dependency model 602 and topology 604. Attributes dependency model 602 may define a dependency between attributes that are the CPU utilization of a container, the CPU, and the CPU capacity. In particular, attribute dependency model 602 defines a dependency as a CPU utilization of a container that is equal to the CPU divided by the CPU capacity. Topology 604 indicates a relationship between a container C1 and itself, thus showing only the container. Based on attributes dependency model 602 and topology 604, attributes dependency graph generator 202 may generate ADG 606 showing the CPU utilization of container C1, CPU of the container C1 and CPU capacity of the container C1 as vertices and a relationship 610, e.g., a quotient of the CPU of the container C1 and the CPU capacity of the container C1, as edges.

In some embodiments, attributes dependency graph generator 202 may use ADGs, such as ADGs 406, 506, and 606 as building blocks to combine into other ADGs. FIG. 7A illustrates ADG 406, ADG 506, and ADG 606 combined into a single ADG 706, according to some embodiments. For example, attributes dependency graph generator 202 may use topology 704 to combine ADG 406, ADG 506, and ADG 606 into ADG 706. Notably, ADG 706 includes the same vertices as ADG 406, ADG 506, and ADG 606 and preserves the relationships 410, 510, and 610 among the vertices.

FIG. 7B illustrates an example pseudo code for generating ADG 706, according to some embodiments. FIG. 7B illustrates pseudo code for Entity, Service and Container classes. The Service and Container classes extend the Entity class. The Entity class may indicate which entities are layered over or layered under other entities. The Service class may instantiate service SV1 and the Container class may instantiate container C1. The Service class defines attributes, such as Requests, CPU Per Request, and Latency, which are attributes of service SV1 and are nodes of ADG 706. Additionally, the Service class defines relationships between the attributes, shown as relationships 410 and 510 in ADG 706. Similarly, the Container class defines attributes CPU usage, CPU utilization, and CPU capacity, which are attributes of container C1 and are nodes in ADG 706. Additionally, the Container class defines relationships between the attributes, shown as an example relationship 610.

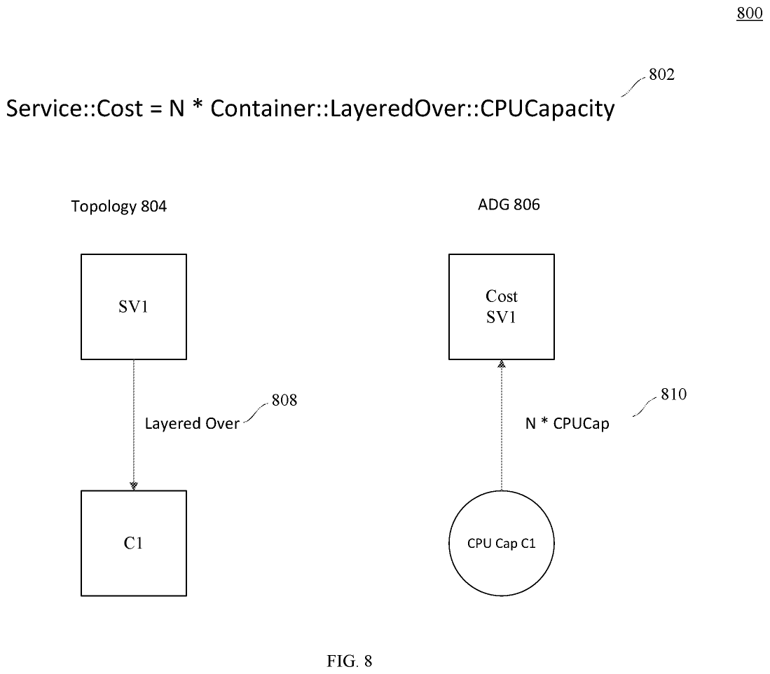

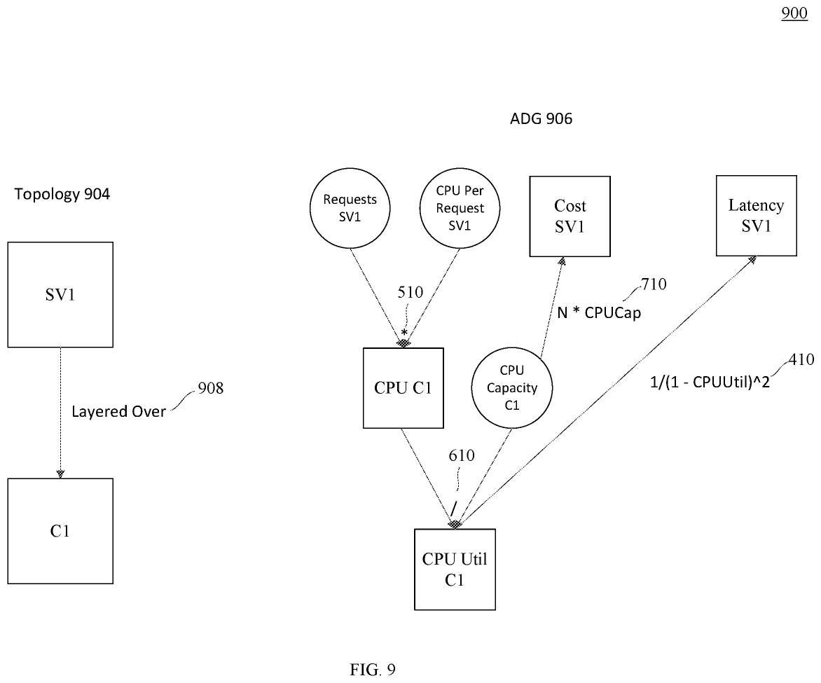

In some embodiments, once ADG 706 is generated, an additional ADG may be added to ADG 706. The additional ADG may be generated after ADG 706 has been created. FIGS. 8-9 illustrate attributes dependency graph generator 202 generating an additional ADG and incorporating the additional ADG into ADG 706. FIG. 8 is a diagram 800 illustrating an attributes dependency model 802, a topology 804, and an ADG 806 that was generated from attributes dependency model 802 and topology 804. Attributes dependency model 802 may define a relationship between a CPU capacity of a container and a cost of service. In particular, attribute dependency model 802 defines a relationship as a cost of service that is equal to the CPU capacity of container multiplied by a constant equal to CPU unit cost. Topology 804 indicates a relationship 808 between a service SV1 and a container C1. Specifically, topology 804 indicates that the service SV1 is layered over the container C1, and may be the same topology as topology 404. Based on attributes dependency model 802 and topology 804, attributes dependency graph generator 202 may generate ADG 806 that shows the cost of service SV1 and CPU capacity of container C1 as vertices, and a relationship 810, e.g., the CPU unit cost multiplied by the CPU capacity of the container, as an edge.

FIG. 9 is a diagram 900 illustrating ADG 806 combined with ADG 706 into a single ADG, according to some embodiments. For example, attributes dependency graph generator 202 may generate ADG 906 that includes ADG 706 and ADG 806. To generate ADG 906, attributes dependency graph generator 202 may identify a common vertex, such as the vertex CPU Capacity C1 that exists in ADG 706 and ADG 806. Attributes dependency graph generator 202 may then incorporate ADG 806 into ADG 706 using the common vertex.

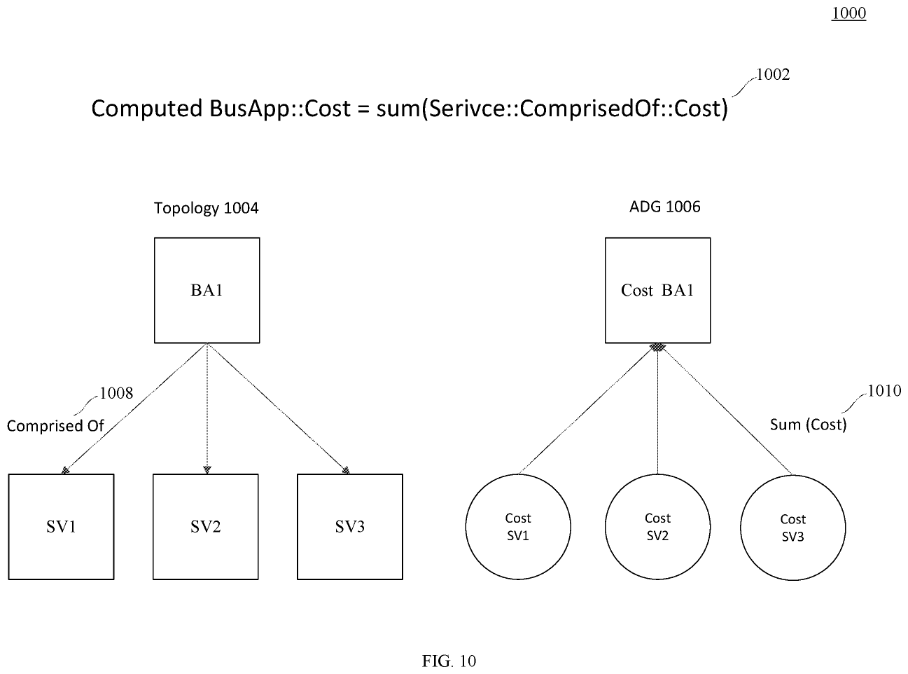

FIG. 10 illustrates an attributes dependency model 1002, a topology 1004, and an ADG 1006 that was generated from attributes dependency model 1002 and topology 1004. Attributes dependency model 1002 may define a dependency among attributes that are a cost of a business application and costs of services. In particular, attribute dependency model 1002 defines a dependency of attributes that are a cost of a business application as a sum of the cost of the services that compose the business application. Topology 1004 indicates a relationship 1008 among the three services SV1, SV2, and SV3 and the business application BA1. Specifically, topology 1004 indicates that the business application BA1 is composed of three services: SV1, SV2, and SV3. Based on attributes dependency model 1002 and topology 1004, attributes dependency graph generator 202 may generate ADG 1006 that shows costs of services SV1, SV2, and SV3 and business application BA1 as vertices, and the relationship 1010, e.g., the sum of costs of services SV1, SV2, and SV3 that is the cost of the business application BA1, as edges.

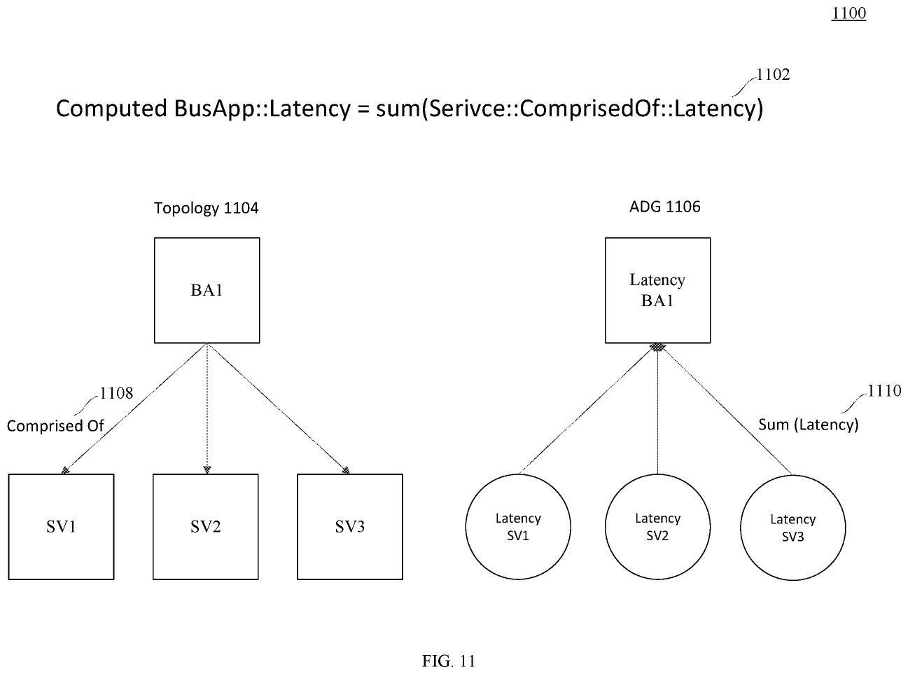

FIG. 11 illustrates an attributes dependency model 1102, a topology 1104, and an ADG 1106 that was generated from attributes dependency model 1102 and topology 1104, according to some embodiments. Attributes dependency model 1102 may define a dependency among attributes that are a latency of a business application and latencies of the services that compose the business application. In particular, attribute dependency model 1102 defines a dependency of an attribute that is a latency of a business application as a sum of attributes that are latencies of services that compose the business application. Topology 1104 indicates a relationship 1108 among the three services SV1, SV2, and SV3 and the business application BA1, and may be the same as topology 1004. Specifically, topology 1104 indicates that the business application BA1 is composed of three services: SV1, SV2, and SV3. Based on attributes dependency model 1102 and topology 1104, attributes dependency graph generator 202 may generate ADG 1106 that shows latencies of services SV1, SV2, and SV3 and business application BA1 as vertices, and the relationship 1110, e.g., the sum of latencies of services SV1, SV2, and SV3 being the latency of the business application BA1, as edges.

Going back to FIG. 2, in some embodiments, attributes dependency graph generator 202 may combine multiple topologies 210 that may cause attributes dependency graph generator 202 to combine ADGs 214. FIG. 12A is a block diagram 1200A that illustrates a combined topology, according to some embodiments. FIG. 12A illustrates topology 1204 that is a topology combined from topology 1004 and three topologies 404. For example, topology 1004 illustrates that business application BA1 comprises of services SV1, SV2, and SV3. The three topologies 404 illustrate that service SV1 is layered over container C1, service SV2 is layered over container C2, and service SV3 is layered over container C3.

FIG. 12B is a block diagram 1200B that illustrates an ADG generated from topology 1204, according to some embodiments. Using topology 1204 shown in FIG. 12A, attribute dependency graph generator 202 may generate an ADG 1206. ADG 1206 may be a combination of three ADGs 906 (shown as ADG 906SV1, ADG 906SV2 and ADG 906SV3), ADG 1006, and ADG 1106. ADG 906SV1 is associated with service SV1, ADG 906SV2 is associated with service SV2 and ADG 906SV3 is associated with service SV3. Notably, FIG. 12B illustrates ADG 906SV1 is its entirety, and only latency and cost portions of ADG 906SV2 and ADG 906SV3. Although not shown, the structure of ADG 906SV2 and ADG 906SV3 is the same as the structure of ADG906SV1, but as applied to container C2 and service SV2, and container C3 and service SV3, respectively.

ADG 1206 includes vertices of ADG 906SV1, ADG 906SV2 and ADG 906SV3 as applied to services SV1, SV2, and SV3. For example, ADG 906SV1 may determine the cost and latency of SV1, ADG 906SV2 may determine the cost and latency of SV2, and ADG906SV may determine the cost and latency of SV3. Next ADG 1006 may be incorporated into ADG 1206 to determine the cost of the business application BA1 as a sum of the cost of SV1, the cost of SV2, and the cost of SV3. Similarly, ADG 1106 may be incorporated into ADG 1206 to determine the latency of the business application BA1 as a sum of the latency of SV1, latency of SV2, and latency of SV3.

Going back to FIG. 2, in some embodiments, attributes dependency graph generator 202 in performance assurance framework 110 may use a machine learning framework. In some embodiments, the machine learning framework may use a linear regression, including a polynomial regression to determine a relationship between input and output attributes. In the polynomial regression, the relationship between the input attribute and the output attribute may be modeled using an n^{th} degree polynomial function, where n is an integer. In some instances, the n^{th} degree polynomial function may be a degree-3 polynomial function, such that the output attribute is a degree-3 polynomial function of an input attribute. Notably, the machine learning framework may also use other types of linear regressions to determine a relationship between the input attribute and the output attribute. The machine learning framework may be trained to determine functions that are associated with the edges in ADG 214 connecting the attributes. To determine the functions, the machine learning framework may be trained on training data. The training data may include attributes and functions of the previously generated attributes dependency graphs.

As discussed above, performance assurance framework 110 may include a user interface. The user interface may display ADG 214 generated using attributes dependency graph generator 202, thereby presenting a user with a visual representation of the resources and performance metrics in the computing environment and the dependencies among different resources in the computing environment. The edges in ADG 214 may also be selectable. Once an edge is selected, the user interface may display a relationship, e.g., a function, that the attributes dependency graph generator 202 determined represents a relationship between the resources.

Notably, the ADGs 214 describes in FIGS. 3-12 are exemplary and there may be other ADGs 214 that may be generated and configured using different attributes dependency models 208 and topologies 210.

In some embodiments, performance assurance framework 110 may receive a constraint model 216. The constraint model 216 may specify constraints, such as latency, budget, etc., associated with the one or more attributes in ADG 214. Typically the attributes in ADG 214 that are assigned constrained are dependent attributes. For example, constraint model 216 may specify that a latency of a business application may be less than the latency of a service level objective (SLO) S, where S is a positive number. In another example, constraint model 216 may define that a budget for operating business application may be B, where B is a positive integer. Constraint model 216 may similarly define constraints for other attributes in ADG 214.

FIG. 12C illustrates an example pseudo code for generating ADG 1206, according to some embodiments. Similarly to FIG. 7B, FIG. 12C illustrates pseudo code for Entity, Service and Container classes. Additionally, the pseudo code in FIG. 12C includes a Business Application class that extends the Entity class. The Business Application class may instantiate the business application BA1. The Business Application class also includes attributes latency and cost, which are vertices in ADG 1206. Additionally, the business application class also includes the constraints for latency and cost, which may be defined in constraint model 216. The constraints for latency and cost are shown in FIGS. 12D and 12E and are associated with BA1 once BA1 is instantiated.

Constraints may be defined using attributes dependency model language or another language. In one embodiment, constraint model 216 may be included in a file and associated with the attributes in the ADG 214. In another embodiment, constraint model 216 may also be included in attributes dependency model 208, such that attributes in ADG 214 may be associated with the constraints when attributes dependency graph generator generates ADG 214. In yet another embodiment, performance assurance framework 110 may receive input that may define constraints for attributes in constraint model 216. For example, in an embodiment where performance assurance framework 110 generates ADG 214 and displays the ADG 214 on a user interface of a computing device, the user interface may receive input that selects a vertex corresponding to an attribute and associates the vertex with a constraint. For example, an input may select an attribute in FIG. 12B that corresponds to a cost of the business application BA1 and associate a constraint S with the cost of the business application BA1.

In some embodiments, performance assurance framework 110 may include a factor graph generator 204. Factor graph generator 204 may be implemented in hardware, software, or a combination of both.

Factor graph generator 204 may receive ADG 214 and constraint model 216 and generate a factor graph 218. Factor graph 218 may be a graph of constraints and variables, where variables represent a portion of resources and performance metrics in the computing environment that are associated with one of applications 108 and satisfy the constraints in constraint model 216. To generate factor graph 218, factor graph generator 204 may identify a vertex in ADG 214 that is associated with a constraint. The vertex is typically a square and represents an attribute that is computed from other attributes. From the vertex, factor graph generator 204 may iteratively traverse one or more paths in ADG 214 in the direction opposite to the direction of the directed edges until the factor graph generator 204 reaches a vertex that corresponds to a free or independent attribute. As discussed above, the free attributes represent resources or performance metrics that are not computed from other in the computing environment 100. Factor graph generator 204 iteratively traverses the paths from the vertex corresponding to an attribute associated with the constraint to the vertices that correspond to the free attributes until all paths are traversed. As factor graph generator 204 traverses the paths, factor graph generator tracks the relationships, e.g., functions between the traversed vertices. Once factor graph generator 204 completes the traversal, factor graph generator 204 may determine the relationship between the attribute associated with the constraint and the free attributes in ADG 214, and generate factor graph 218 that represents the relationships. In factor graph 218, and an attribute associated with a constraint may be a variable, and free attributes may be constraints.

FIG. 12D is a diagram of ADG 1206 with a budget B constraint on the cost of the business application BA1. To determine a factor graph for the cost of the business application BA1, factor graph generator 204 may iteratively traverse ADG 1206 from the node corresponding to the cost of the business application BA1 and in the direction opposite of the edges ending at that node. These are the edges shown in bold in FIG. 12D. For example, factor graph generator 204 may begin to traverse ADG 1206 at the node Cost BA1 (node 1212) to the node Cost SV1 (node 1214), and from the node Cost SV1 to the node CPU Capacity C1 (node 1216). Since the node CPU Capacity C1 is a free attribute, factor graph generator 204 terminates the traversal at the node CPU Capacity C1. Next, factor graph generator 204 traverses from the node Cost BA1 to the node Cost SV2, and from the node Cost SV2 to the node CPU Capacity C2 (shown in part). Since the node CPU Capacity C2 is a free attribute, factor graph generator 204 terminates the traversal at the node CPU Capacity C2. Next, factor graph generator 204 traverses from the node Cost BA1 to the node Cost SV3, and from the node Cost SV3 to the node CPU Capacity C3 (shown in part). Since the node CPU Capacity C3 is a free attribute, factor graph generator 204 terminates the traversal at the node CPU Capacity C3.

As discussed above, as the factor graph generator 204 traverses ADG 1206, factor graph generator 204 tracks the relationships associated with the edges that factor graph generator 204 traverses. Factor graph generator 204 may then combine the relationships into an equation that illustrates a cost of the business application BA1 in terms of the CPU capacity C1, CPU capacity C2 and CPU capacity C3 as follows:

$$\begin{matrix}BA 1 ∷ Cost = SV 1 ∷ Cost + SV 2 ∷ Cost + SV 3 ∷ Cost \\ = N * C 1 ∷ CPUCapacity + \\ = N * C 2 ∷ CPUCapacity + \\ = N * C 3 ∷ CPUCapacity\end{matrix} \qquad Equation ( l )$$

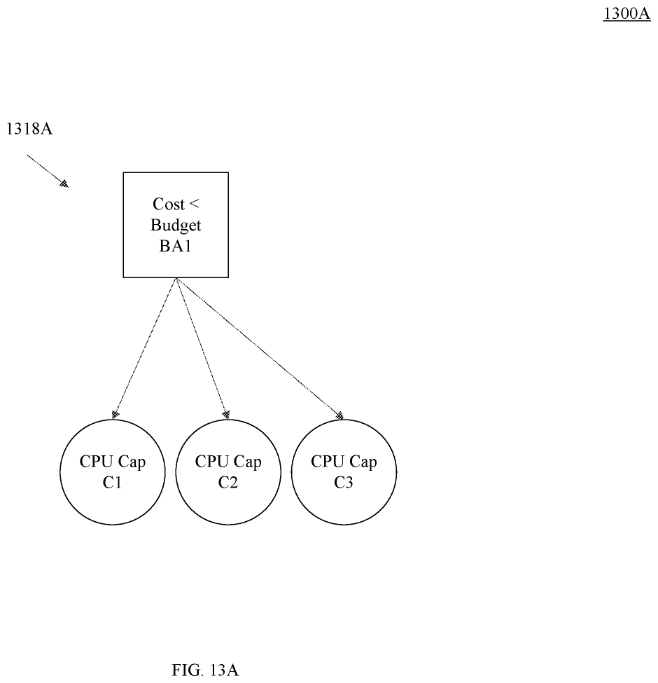

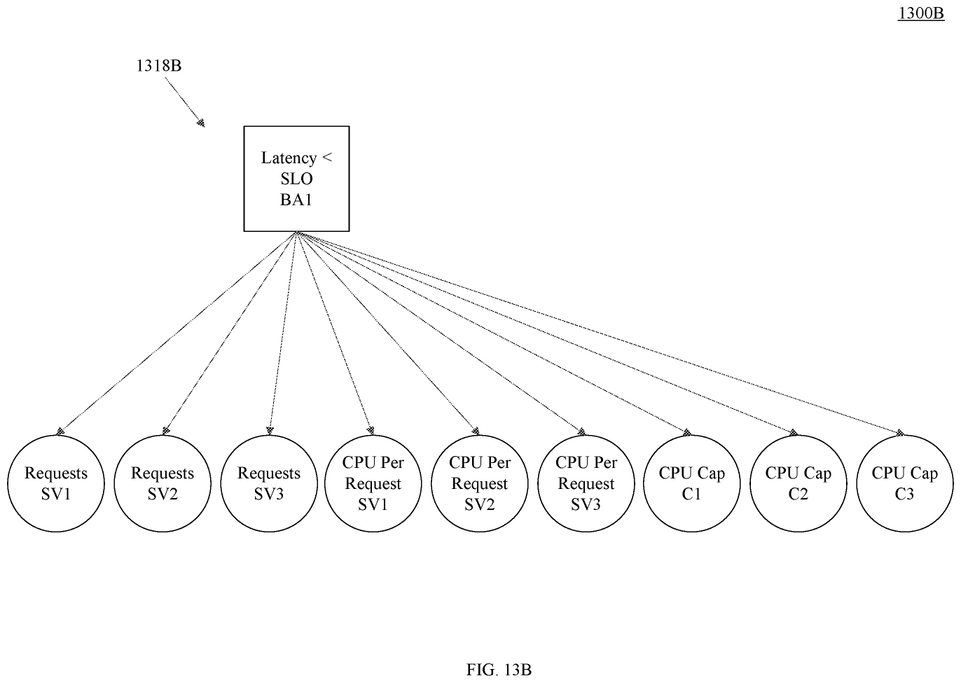

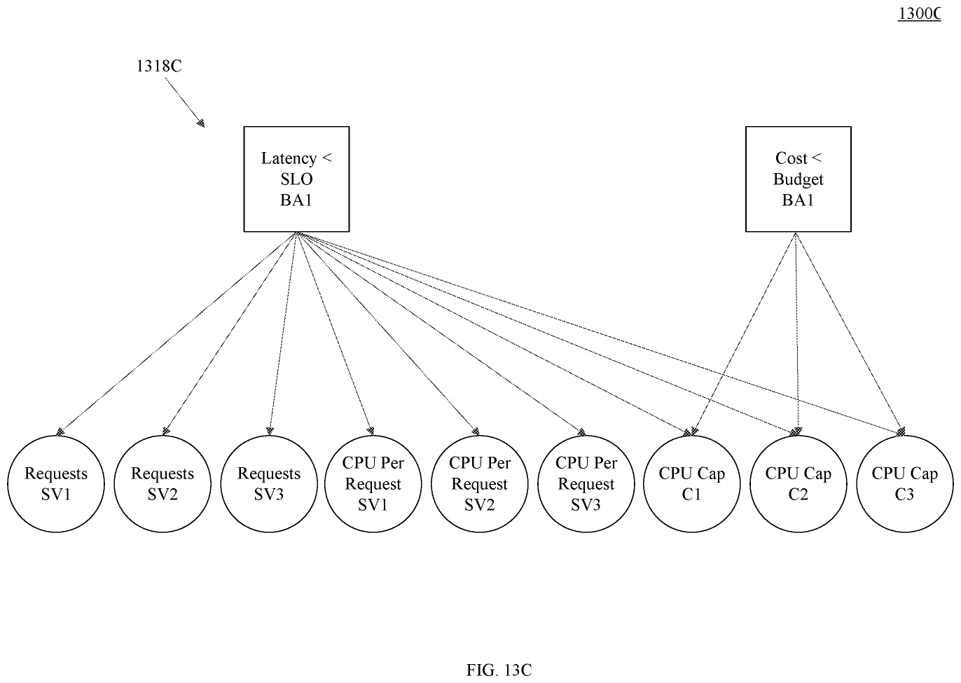

Based on the relationships between the cost of the business application BA1 in terms of the CPU capacity C1, CPU capacity C2 and CPU capacity C3, factor graph generator 204 may generate a factor graph. FIG. 13A is a diagram 1300A illustrating a factor graph, according to some embodiments. Factor graph 1318A shown in FIG. 13A represents the cost of the business application BA1 in terms of the cost of the CPU capacity of containers C1, C2, and C3 that is represented in Equation (1), and discussed in FIG. 12D.

In factor graph 1318A, the cost of the CPU capacity of containers C1, C2, and C3 may be variables that represent a portion of resources in the computing environment 100 that may be allocated to the business application BA1 subject to a constraint. As discussed above, the constraint may be the cost is less than the budget B of the business application BA1.

FIG. 12E is a diagram of ADG 1206 having a latency for a service level objective (SLO) constraint S on the latency of the business application BA1. To determine a factor graph for the latency of the business application BA1, factor graph generator 204 may iteratively traverse ADG 1206 from the node corresponding to the latency of the business application BA1 (node 1220) and in the direction opposite of the edges ending at node 1220. These are the edges shown in bold in FIG. 12E. For example, factor graph generator 204 may begin to traverse ADG 1206 from the node Latency BA1 (node 1220) to the node Latency SV1 (node 1222), and from the node Latency SV1 to the node CPU Util C1 (node 1224). At node CPU Util C1, factor graph generator 204 may determine that there are multiple paths, which factor graph generator 204 may traverse iteratively. For example, factor graph generator 204 may traverse from the node CPU Util C1 to the node CPU capacity C1 (node 1226) which is a free attribute. Next, factor graph generator 204 may traverse from node CPU Util C1 to the node CPU C1 (node 1228). From the node CPU C1, factor graph generator 204 may again determine that there are multiple paths, and iteratively traverse to the node Requests SV1 (1230), which is a free attribute, and then to the node CPU Per Request SV1 (node 1232), which is also a free attribute. Once factor generator 204 has identified the free attributes that are reachable from the Latency SV1 node, factor graph generator 204 may iteratively traverse the node Latency SV2 (until the nodes with free attributes CPU Capacity C2, Requests SV2, and CPU Per Request SV2 are reached) and the node Latency SV3 (until the nodes with free attributes CPU Capacity C3, Requests SV3, and CPU Per Request SV3 are reached).

As discussed above, as the factor graph generator 204 traverses ADG 1206, factor graph generator 204 tracks the relationships associated with the edges that factor graph generator 204 traverses. Factor graph generator 204 may then combine the relationships into an equation that illustrates a latency of the business application BA1 in terms of the CPU Capacity C1, Requests SV1, CPU Per Request SV1, CPU Capacity C2, Requests SV2, CPU Per Request SV2, and CPU Capacity C3, Requests SV3, and CPU Per Request SV3 as follows:

$$Equation ( 2 )$$

$$\begin{matrix}BA 1 ∷ Latency = SV 1 ∷ Latency + SV 2 ∷ Latency + SV 3 ∷ Latency \\ = \frac{1}{{( 1 - C 1 ∷ CPUUtil )}^{2}} + \frac{1}{{( 1 - C 2 ∷ CPUUtil )}^{2}} + \frac{1}{{( 1 - C 3 ∷ CPUUtil )}^{2}} \\ = \begin{matrix}\frac{1}{{( 1 - \frac{C 1 ∷ CPU}{C 1 ∷ CPUCapacity} )}^{2}} + \frac{1}{{( 1 - \frac{C 2 ∷ CPU}{C 2 ∷ CPUCapacity} )}^{2}} + \\ \frac{1}{{( 1 - \frac{C 3 ∷ CPU}{C 3 ∷ CPUCapacity} )}^{2}}\end{matrix} \\ = \begin{matrix}\frac{1}{{( 1 - \frac{SV 1 ∷ Requests * SV 1 ∷ CPUPerRequest}{C 1 ∷ CPUCapacity} )}^{2}} + \\ \frac{1}{{( 1 - \frac{SV 2 ∷ Requests * SV 2 ∷ CPUPerRequest}{C 2 ∷ CPUCapacity} )}^{2}} + \\ \frac{1}{{( 1 - \frac{SV 3 ∷ Requests * SV 3 ∷ CPUPerRequest}{C 3 ∷ CPUCapacity} )}^{2}} +\end{matrix}\end{matrix}$$

Based on the relationships between the latency of the business application BA1 in terms of the CPU capacity C1, Requests SV1, CPU Per Request SV1, CPU capacity C2, Requests SV2, CPU Per Request SV2, CPU capacity C3, Requests SV3, and CPU Per Request SV3, factor graph generator 204 may generate a factor graph. FIG. 13B is a diagram 1300B illustrating a factor graph, according to some embodiments. Factor graph 1318B shown in FIG. 13B represents the latency of the business application BA1 in terms of CPU capacity C1, Requests SV1, CPU Per Request SV1, CPU capacity C2, Requests SV2, CPU Per Request SV2, CPU capacity C3, Requests SV3, and CPU Per Request SV3 that is represented in Equation (2).

In factor graph 1318B, the CPU capacity C1, Requests SV1, CPU Per Request SV1, CPU capacity C2, Requests SV2, CPU Per Request SV2, CPU capacity C3, Requests SV3, and CPU Per Request SV3 may represent resources and performance metrics in computing environment that may be associated with the business application BA1 such that the latency of the business application BA1 is less than S.

In some embodiments, factor graph generator 204 may combine factor graphs representing different resources for an attribute. For example, factor graph generator 204 may combine factor graph 1308A representing cost of the business application BA1 and factor graph 1308B representing latency of the business application BA1. FIG. 13C is a diagram 1300C illustrating a factor graph, according to some embodiments. FIG. 13C illustrates factor graph 1318C that factor graph generator 204 generated from factor graphs 1318A and 1318B.

Going back to FIG. 2, performance assurance framework 110 may include a constraints resolution module 206. Constraints resolution module 206 may receive factor graph 218 and generate resource assignments 220 that may be used by one or more applications included in factor graph 218. With reference to factor graph 1318C in FIG. 13C, constraints resolution module 206 may determine resources assignments 220 from the one or more of CPU capacity of containers C1, C2, and C3 that may satisfy budget B of the business application BA1. Constraints resolution module 206 may also determine resources assignments 220 from the one or more of CPU capacity C1, Requests SV1, CPU Per Request SV1, CPU capacity C2, Requests SV2, CPU Per Request SV2, CPU capacity C3, Requests SV3, and CPU Per Request SV3 to determine the latency of the business application BA1 such that the latency is less than latency S.

To determine resource assignments 220, constraints resolution module 206 may include one or more algorithms that determine an assignment for variables given a set of constraints. Example algorithms may include a forward checking, backtracking search, constraint propagation, and local search algorithms. The algorithms may assign some or all resources specified in factor graph 218 to the business application BA1 in one or more combinations, such that the assignment satisfies given constraints. The assignment may further be based on functions associated with the traversed edges, such as the functions in Equations (1) and (2). Constraints resolution module 206 may select one of the combinations to maximize some objective function specified in the algorithm. In some embodiments, constraints resolution module 206 may evaluate the factor graph 218 and select one or a combination of the algorithms to determine resource assignments 220 based on the evaluation.

Notably, the resource assignments 220 to the business application BA1 are exemplary, and performance assurance framework 110 may similarly determine resource assignments 220 to other applications in computing environment 100. Once performance assurance framework 110 determines resource assignments 220, performance assurance framework 110 may reconfigure resources in computing environment 100 in accordance with the resource assignments 220. Alternatively, performance assurance framework 110 may provide resource assignments 220 as recommendations that may be stored in a file that may be transmitted over network 102 or display the resource assignments 220 on a user interface of a computing device.

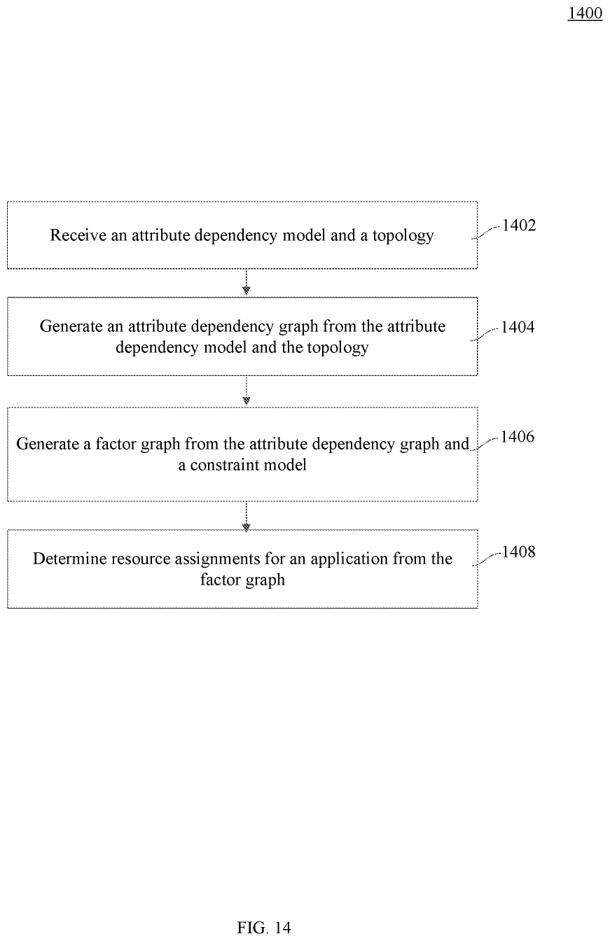

FIG. 14 is a flowchart of a method 1400 for assigning computing resources to an application, according to an embodiment. Method 1400 may be performed using hardware and/or software components described in FIGS. 1-13. Note that one or more of the operations may be deleted, combined, or performed in a different order as appropriate.

At operation 1402, an attribute dependency model and a topology are received. For example, attribute dependency graph generator 202 may receive attribute dependency model 208 and topology 210. As discussed above, attribute dependency model 208 may define attributes that correspond to resources and performance metrics in computing environment 100. In some instances, attribute dependency model 208 may also specify relationships between different attributes. As also discussed above, topology 210 may include relationships between particular computing resources in computing environment 100.

At operation 1404, attribute dependency graph is generated. For example, attributes dependency graph generator 202 may generate ADG 214 from attribute dependency model 208 and topology 210. ADG 214 may include attributes as vertices, and directed edges that are associated with a relationship between the attributes. The relationship between the attributes may be included in attribute dependency model 208 or determined using a machine learning framework.

At operation 1406, factor graph is generated from an attribute dependency graph and a constraint model. For example, factor graph generator 204 may receive constraint model 216 and ADG 214 and generate factor graph 218. Using constraint model 216 factor graph generator 204 may identify nodes in ADG 214 that are associated with the constraint. From the identified node, factor graph generator 204 may iteratively traverse the directed edges in the opposite direction until factor graph generator 204 reaches free or independent nodes in ADG 214. During the traversal, factor graph generator 204 may also track the functions associated with the traversed edges. Factor graph generator 204 may generate factor graph 218 that illustrates a relationship between the resources associated with the constraint, e.g., an application, and the resources corresponding to the free attributes, e.g., resources in computing environment 100. Factor graph generator 204 may also use the traversed edges to generate an equation representing the relationship.

At operation 1408, resources in the computing environment are assigned to an application based on the factor graph. For example, constraints resolution module 206 receives a factor graph 218 and uses one of the search algorithms to determine resource assignments 220 to an application based on the resources identified in factor graph 218. Constraints resolution module 206 may determine resource assignments 220 such that the assignments maximize some objective function.

FIG. 15 is a diagram of a computer system 1500 suitable for implementing, the systems and methods described in FIGS. 1-14 is illustrated.

In accordance with various embodiments of the disclosure, computer system 1500, such as a computer and/or a server, includes various resources, such as a bus 1502 or other communication mechanism for communicating information, which interconnects subsystems and components, such as a processing component 1504 (e.g., processor, micro-controller, digital signal processor (DSP), graphics processing unit (GPU), etc.), a system memory component 1506 (e.g., RAM), a static storage component 1508 (e.g., ROM), a disk drive component 1610 (e.g., magnetic or optical), a network interface component 1012 (e.g., modem or Ethernet card), a display component 1514 (e.g., CRT or LCD), an input component 1518 (e.g., keyboard, keypad, or virtual keyboard), a cursor control component 1520 (e.g., mouse, pointer, or trackball), a location determination component 1522 (e.g., a Global Positioning System (GPS) device as illustrated, a cell tower triangulation device, and/or a variety of other location determination devices known in the art), and/or a camera component 1523. In one implementation, the disk drive component 1510 may comprise a database having one or more disk drive components.

In accordance with embodiments of the disclosure, the computer system 1500 performs specific operations by the processing component 1504 executing one or more sequences of instructions contained in the memory component 1506, such as described herein with respect to the mobile communications devices, mobile devices, and/or servers. Such instructions may be read into the system memory component 1506 from another computer readable medium, such as the static storage component 1508 or the disk drive component 1510. In other embodiments, hard-wired circuitry may be used in place of or in combination with software instructions to implement the disclosure.

Logic may be encoded in a computer readable medium, which may refer to any medium that participates in providing instructions to the processing component 1504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1510, volatile media includes dynamic memory, such as the system memory component 1506, and transmission media includes coaxial cables, copper wire, and fiber optics, including wires that comprise the bus 1502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 1500. In various other embodiments of the disclosure, a plurality of the computer systems 1500 coupled by a communication link 1524 to the network (e.g., such as a LAN, WLAN, PTSN, and/or various other wired or wireless networks, including telecommunications, mobile, and cellular phone networks) may perform instruction sequences to practice the disclosure in coordination with one another.

The computer system 1500 may transmit and receive messages, data, information and instructions, including one or more programs (i.e., application code) through the communication link 1524 and the network interface component 1512. The network interface component 1512 may include an antenna, either separate or integrated, to enable transmission and reception via the communication link 1524. Received program code may be executed by processing component 1504 as received and/or stored in disk drive component 1510 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a memory configured to store instructions; and
a processor coupled to the memory and configured to read the instructions from the memory to cause the system to perform operations, the operations comprising:
generating an attributes dependency graph from an attributes dependency model defining a plurality of attributes and a topology, wherein the plurality of attributes correspond to a plurality of resources and performance metrics in a computing environment, and wherein a plurality of vertices in the attributes dependency graph correspond to the plurality of attributes connected by a plurality of edges;
generating a factor graph from the attributes dependency graph and a constraints model, the constraints model specifying at least one constraint for an application executing in the computing environment, the application associated with an attribute in the attributes dependency graph; and
allocating a subset of resources in the computing environment to the application based on the factor graph.

2. The system of claim 1, wherein the topology defines relationships between the plurality of entities in the computing environment.

3. The system of claim 1, wherein the plurality of edges are directed edges, and an edge corresponds to a function identifying a relationship between at least two attributes associated with two vertices connected by the edge.

4. The system of claim 3, wherein the attributes dependency model includes the function corresponding to the edge in the plurality of edges.

5. The system of claim 3, wherein the operations further comprise:
determining, using a machine learning framework trained on data collected from the computing environment, the function associated with the edge.

6. The system of claim 1, wherein the operations that generate the factor graph further comprise:
identifying the attribute associated with the at least one constraint;
iteratively traversing, from a vertex associated with the attribute, a subset of edges in the attribute dependency graph, until a subset of vertices corresponding to a subset of independent attributes in the plurality of attributes is identified; and
generating the factor graph from the attribute associated with the at least one constraint and the subset of independent attributes.

7. The system of claim 6, wherein the subset of edges are directed edges and iteratively traversing occurs in a direction opposite of directions of the directed edges.

8. The system of claim 6, wherein the operations further comprise:
tracking a subset of functions associated with the subset of edges.

9. The system of claim 8, wherein the subset of resources are allocated based on the subset of functions.

10. The system of claim 1, wherein an attribute in the plurality of attributes is an independent attribute that corresponds to a resource in the plurality of resources that is independent of other resources in the plurality of resources in the computing environment.

11. The system of claim 1, wherein an attribute in the plurality of attributes is a dependent attribute that depends on other attributes in the plurality of attributes, wherein the other attributes correspond to the performance metrics in the computing environment.

12. A method comprising:
generating, using a processor, an attributes dependency graph from an attributes dependency model defining a plurality of attributes and a topology, wherein the plurality of attributes correspond to a plurality of resources and performance metrics in a computing environment, and wherein a plurality of vertices in the attributes dependency graph correspond to the plurality of attributes connected by a plurality of edges;
generating a factor graph from the attributes dependency graph and a constraints model, the constraints model specifying at least one constraint for an application executing in the computing environment, the application associated with an attribute in the attributes dependency graph; and
configuring a subset of resources in the computing environment to the application based on the factor graph.

13. The method of claim 12, wherein the topology defines relationships between a plurality of entities in the computing environment.

14. The method of claim 12, wherein the plurality of edges are directed edges, and an edge corresponds to a function identifying a relationship between at least two attributes associated with two vertices connected by the edge.

15. The method of claim 12, further comprising:
identifying the attribute associated with the at least one constraint;
iteratively traversing, from a vertex associated with the attribute, a subset of edges in the attribute dependency graph, until a subset of vertices corresponding to a subset of independent attributes in the plurality of attributes is identified; and
generating the factor graph from the attribute associated with the constraint and the subset of independent attributes.

16. The method of claim 15, further comprising:
tracking a subset of functions associated with the subset of edges, wherein the subset of resources are allocated based on the subset of functions.

17. The method of claim 12, wherein an attribute in the plurality of attributes is an independent attribute that corresponds to a resource in the plurality of resources that is independent of other resources in the plurality of resources in the computing environment.

18. The method of claim 12, wherein an attribute in the plurality of attributes is a dependent attribute that depends on other attributes in the plurality of attributes, wherein the other attributes correspond to the performance metrics in the computing environment.

19. A non-transitory computer readable medium having instructions stored thereon, that when executed by a processor cause the processor to perform operations, the operations comprising:
generating an attributes dependency graph from an attributes dependency model defining a plurality of attributes and a topology, wherein the plurality of attributes correspond to a plurality of resources and performance metrics in a computing environment, wherein a plurality of vertices in the attributes dependency graph correspond to the plurality of attributes connected by a plurality of edges, and wherein the topology defines relationships between the plurality of resources and performance metrics;
generating a factor graph from the attributes dependency graph and a constraints model, the constraints model specifying at least one constraint for an application executing in the computing environment, the application associated with an attribute in the attributes dependency graph; and
allocating a subset of resources in the computing environment to the application based on the factor graph.

20. The non-transitory computer readable medium of claim 19, wherein the operations further comprise:
identifying the attribute associated with the at least one constraint;
iteratively traversing, from a vertex associated with the attribute, a subset of edges in the attribute dependency graph, until a subset of vertices corresponding to a subset of independent attributes in the plurality of attributes is identified; and
generating the factor graph from the attribute associated with the at least one constraint and the subset of independent attributes.
